(19) United States
(12) Patent Application Publication
(10) Pub. No.: US 2019/0129008 A1
(43) Pub. Date: May 2, 2019

(54) WIDE-ANGLE HIGH-RESOLUTION SOLID-STATE LIDAR SYSTEM USING GRATING LOBES

(71) Applicant: OURS Technology, Inc., Mountain View, CA (US)

(72) Inventors: Sen Lin, Mountain View, CA (US); Zhangxi Tan, Mountain View, CA (US)

(73) Assignee: OURS Technology, Inc., Mountain View, CA (US)

(21) Appl. No.: 15/963,932

(22) Filed: Apr. 26, 2018

Related U.S. Application Data
(60) Provisional application No. 62/490,514, filed on Apr. 26, 2017.
(60) Provisional application No. 62/490,501, filed on Apr. 26, 2017.
(60) Provisional application No. 62/500,812, filed on May 3, 2017.
(60) Provisional application No. 62/511,287, filed on May 25, 2017.
(60) Provisional application No. 62/511,285, filed on May 25, 2017.
(60) Provisional application No. 62/511,288, filed on May 25, 2017.
(60) Provisional application No. 62/532,814, filed on Jul. 14, 2017.

(51) Int. Cl. G01S 7/48; G01S 17/89; G01S 17/06; G01S 7/484; G01S 7/486

(52) U.S. Cl. CPC G01S 7/4804; G01S 17/89; G01S 7/4863; G01S 7/484; G01S 17/06

(57) ABSTRACT

A method and system for a wide-angle high-resolution solid-state LIDAR system using multiple grating lobes includes a laser driver providing a current to a laser, and the laser producing laser energy. A splitter receiving the laser energy, and dividing the laser energy. The divided laser energy is provided to an optical antenna, where the optical antenna is connected to an optical phase shifter. The optical phase shifter controls the phase of the beams to be emitted from the antennas. The optical antenna emits beams, and the emitted beams include a first lobe and a second lobe. A photoreceiver having an optical receiver receives reflected optical signals, where the reflected optical signals are reflections of the first lobe and second lobe. Then, the reflected optical signals are converted into electronic signals in parallel.

### PRIORITY

This application claims priority to and the benefit of U.S. Provisional Application Ser. No. 62/490,514, entitled, “Wide-Angle High-Resolution Solid-State LIDAR System Based on Optical Phased Array and Photodetector Array Using Multiple Grating Lobes”, filed Apr. 26, 2017; U.S. Provisional Application Ser. No. 62/490,501, entitled, “Two-Dimensional Scanning High-Resolution Solid-State LIDAR System Based on Optical Phased Array and Photodetector Array Using Multiple Grating Lobes”, filed Apr. 26, 2017; U.S. Provisional Application Ser. No. 62/500,812, entitled, “Line-Scan High-Resolution Solid-State Light Detection And Ranging (LIDAR) System Based on Optical Phased Array and Photodetector Array”, filed May 3, 2017; U.S. Provisional Application Ser. No. 62/511,287, entitled, “Solid-State Light Detection and Ranging (LIDAR) System with Real-Time Self-Calibration”, filed May 25, 2017; U.S. Provisional Application Ser. No. 62/511,285, entitled, “Microprocessor-Assisted Solid-State Light Detection and Ranging (LIDAR) Calibration”, filed May 25, 2017; U.S. Provisional Application Ser. No. 62/511,288, entitled, “Adaptive Zooming in Solid-State Light Detection and Ranging (LIDAR) System Using Optical Phased Array”, filed May 25, 2017; and U.S. Provisional Application Ser. No. 62/532,814, entitled, “Solid-State Light Detection and Ranging System Based on an Optical Phased Array with an Optical Power Distribution Network”, filed Jul. 14, 2017, the entire contents of each of which are incorporated herein by reference and relied upon.

### BACKGROUND

The present disclosure is in the technical field of solid-state LIDAR.

Generally, LIDAR, which stands for Light Detection and Ranging, is a remote sensing method that uses a laser to measure ranges or distances to a target object. The method typically measures distance to a target by illuminating the target with the laser and measuring the reflected signals with a sensor. Differences in laser return time and frequency may be gathered to generate precise, three-dimensional representations regarding the shape and surface characteristics of the target.

Typically, LIDAR uses ultraviolet, visible, or near infrared light to image objects. It may target a wide range of materials, including metal or non-metal objects, rocks, rain, chemical compounds, aerosols, clouds, etc. Further, a laser beam may be capable of mapping physical features with very high resolutions.

### SUMMARY

The present disclosure provides new and innovative methods and systems for a wide-angle high resolution solid-state LIDAR system using grating lobes. An example method includes a laser driver providing a current to a laser, and the laser producing laser energy. A splitter receiving the laser energy, and dividing the laser energy. The divided laser energy is provided to an optical antenna, where the optical antenna is connected to an optical phase shifters. The optical phase shifter controls the phase of the beams to be emitted from the antennas. The optical antenna emits beams, and the emitted beams include a first lobe and a second lobe. A photoreceiver having an optical receiver receives reflected optical signals, where the reflected optical signals are reflections of the first lobe and second lobe. Then, the reflected optical signals are converted into electronic signals in parallel.

An example system includes a control circuit, and a LIDAR signal processor, the LIDAR signal processor is located within the control circuit. Further, the example system includes a transmitter and a receiver. The transmitter includes an optical phased array circuit, and an optical phased array driver. The optical phased array driver is in communication with the control circuit and controls the optical phased array circuit. The transmitter further includes a laser and a laser driver. The laser driver is in communication with the LIDAR signal processor and drives the laser. The receiver includes a photoreceiver and a receiver front end circuit. The receiver front end circuit is in communication with the LIDAR signal processor and is connected to the photoreceiver.

Additional features and advantages of the disclosed methods and system are described in, and will be apparent from, the following Detailed Description and the Figures.

### BRIEF DESCRIPTION OF THE DRAWINGS

FIG. 1 is a concept diagram of an optical phased array of the wide-angle high resolution solid-state LIDAR system using grating lobes according to an example of the present disclosure.

FIG. 2 is a perspective view of an optical phased array of the wide-angle high resolution solid-state LIDAR system using grating lobes according to an example of the present disclosure.

FIG. 3 is a block system diagram of the wide-angle high resolution solid-state LIDAR system using grating lobes according to an example of the present disclosure.

FIG. 4 is a flowchart illustrating an example method for using a wide-angle high resolution solid-state LIDAR system using grating lobes.

### DETAILED DESCRIPTION

Generally, conventional LIDAR systems employ mechanical moving parts to steer a laser beam. They are generally considered bulky, incredibly costly and unreliable for many applications. These mechanical moving parts typically are the largest and most expensive part of a laser-scanning system. Generally, Solid-state LIDAR systems can overcome these issues by eliminating moving and mechanical parts. For example, by using the same manufacturing technology as silicon microchips, LIDAR systems can be incredibly small and inexpensive, without sacrificing loss in performance.

An optical phased array (OPA) is typically used to realize low-cost solid-state LIDARs. Generally, a phased array is an array of unmoving antennas creating light beams which can be steered to point in different directions. The beams produced by the antennas include a main lobe and other ancillary side lobes. The main lobe is the lobe containing the maximum power, and exhibits the greatest field strength. Side lobes, or grating lobes, are ancillary lobes produced by the antennas.

Traditionally, the OPA in a solid-state LIDAR uses the main lobe to scan the field-of-view (FOV) and collect the depth information of a target. In such a case, the grating lobes usually limit the steerable range of the main lobe and thus the total FOV angle. The main lobe and grating lobes may be generated by constructive interference of optical radiation from the antennas. Therefore, generally the side lobes are covered up or cut out of view in order for the main lobe to have the widest FOV. Typically, reducing the pitch of phased array antennas (or distance between the phased array antennas) increases the steerable range. However, optical crosstalk may limit the minimum feasible pitch. Moreover, reducing the pitch widens the beam divergence of main lobe when the total number of antennas is fixed. Therefore, the actual resolution of the LIDAR is not improved. Further, not utilizing the grating lobes produced by an optical phased array wastes energy.

In an example, the present disclosure remedies the above noted deficiencies by utilizing a solid-state LIDAR system that incorporates an optical phased array and/or an optical receiver array having photodetectors, pixels, photodiodes, or integrated photonic circuits. The system may be constructed to utilize grating lobes produced by an OPA in addition to the main lobe for scanning and ranging. In an example of the present disclosure, output of the antennas is optimized so that the steering windows of the main lobes and grating lobes may be stitched together to from a wide field-of-view by having optical receivers in a receiver chip/circuit that will capture reflections from the main lobes and the grating lobes. Aspects of the present disclosure can efficiently improve the scanning angle and resolution for solid-state LIDAR.

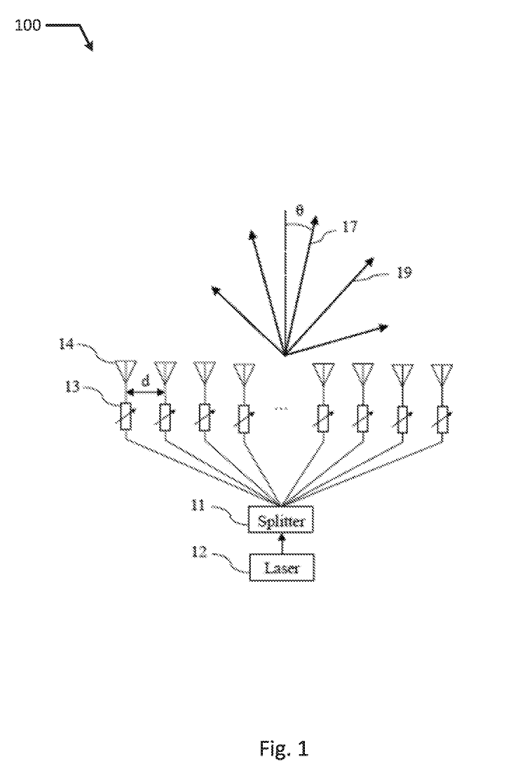

FIG. 1 depicts a transmitter concept diagram of an optical phased array (OPA) of the wide-angle high resolution solid-state LIDAR system using grating lobes according to an example of the present disclosure. The OPA 100 contains a plurality of optical antennas 14 with uniform pitch (d) between them. The pitch d between the antennas may control the angle and number of lobes produced by the antennas. The optical antennas 14 emit light energy that forms, though constructive interferences, a beam or beams that include a main lobe 17 and grating lobes 19. For example, if the pitch d is very large, the angle θ of the main lobe 17 and grating lobes 19 may be very small, and more grating lobes or main lobes may be created. However, power from laser 12 is split by splitter 11 among the lobes. Therefore, the existence of too many lobes is not ideal as power split equally between many lobes would cause each lobe to have less power, creating a weaker beam. Alternatively, if the pitch d is small, the angle θ of the lobes may be larger, providing for fewer lobes. However, if the pitch d is too small, there may be undesirable optical cross talk between the antennas. Generally, the pitch d will be adjusted so that the lobes in total will be between 60-120° , generally leaving a single lobe to be between 30-60°. For example, there may be as few as two lobes utilized (one main lobe and one grating lobe), or as many as seven total lobes created or utilized by the antennas. Alternatively, more or less than seven lobes may be utilized depending on the number of OPAs used, the target to be imaged, the distance to the target, functionality of the antennas, etc.

In exemplary FIG. 1, each antenna 14 is connected to an optical phase shifter 13 that controls the phase of the wave emitted from the antenna 14. By controlling the phase of the wave emitted from antenna 14, the OPA 100 is able to steer the direction of the beams emitted. The OPA forms laser beams at certain angles due to constructive interference (main lobe 17 and grating lobes 19). A plurality of laser beams formed by the OPA 100, including the main lobe 17 and the grating lobes 19, are used together for scanning and ranging. These lobes are steered together in the same direction by tuning the phase difference between adjacent antennas.

The power splitter 11 divides optical power from the laser source 12. This division of power between antennas may be equal or unequal. From the system perspective, the use of photodetector array or optical receiver array in a reception module to receive reflected signals enables the use of more than one lobe for ranging and imaging. From the transmitter perspective, grating lobes can be directly generated and optimized by increasing the pitch between antennas.

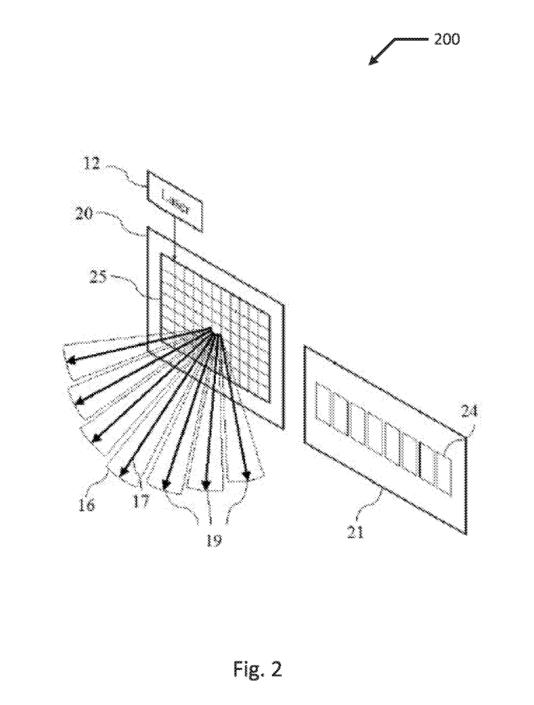

FIG. 2 shows a perspective view of an optical phased array of the wide-angle high resolution solid-state LIDAR system using grating lobes according to an example of the present disclosure. The system 200 depicts a transmitter chip 20 and a receiver chip 21. The transmitter chip 20 includes an OPA 25. When the pitch of the antennas is adjusted according to the present disclosure, laser beams having main lobe 17 and grating lobes 19, emitted from the same OPA 25, only need to steer in a relatively small window 16. The sum of the steering windows 16, including windows for the main lobe 17 and grating lobes 19, provides a wide field-of-view. For the purposes of imaging, these steering windows 16 can be stitched together forming a wider FOV than possible if only utilizing the main lobe 17 for imaging. The OPA 25 is implemented on the transmitter chip 20 using integrated optical circuits. Generally, an integrated optical circuit integrates multiple (at least two) photonic functions. Integrated optical circuits may provide functions for information signals imposed on optical wavelengths.

A laser 12 is connected to the transmitter chip 20. Generally, a laser generates an intense beam of coherent monochromatic light, or other electromagnetic radiation, by stimulating the emission of photons from excited atoms or molecules. Laser 12 can be an external module connecting to the transmitter chip 20 with a fiber-to-chip coupler. Alternatively, the laser 12 can be a semiconductor device, such as a laser diode, that is directly mounted on the transmitter chip. A laser diode creates a laser beam at the diode's junction. The transmitter chip may optionally also include an on-chip waveguide. Generally, a waveguide structure may guide waves, such as optical waves, and may enable a signal to propagate with minimal loss of energy by restricting expansion to one or two dimensions. If a laser diode is used as the laser 12, the laser diode may be coupled to the on-chip waveguide.

The receiver chip 21, or photoreceiver 21, contains an array of optical receivers 24. These optical receivers 24 may include photodiodes, pixels, photodetectors, or integrated photonic circuits. The optical receivers 24 can be one-dimensional or two-dimensional. The number of optical receivers 24 may be equivalent to the number of lobes 17 and 19. Alternatively, the number of optical receivers 24 may not be the same as the number of lobes created by the OPA. Using a plurality of optical receivers 24, multiple reflection points in the field of view can be imaged. Therefore, unlike the conventional method of using only the main lobe for imaging, when the grating lobes and main lobes are reflected there is more than one optical receiver 24 able to receive the reflected signal. The received signals can be separated and processed in parallel. This way, a wider steering angle and higher resolution can be achieved by breaking the limitations imposed by the conventional OPAs using only the main lobe. In addition, laser power is utilized in a more efficient way by preserving grating lobes.

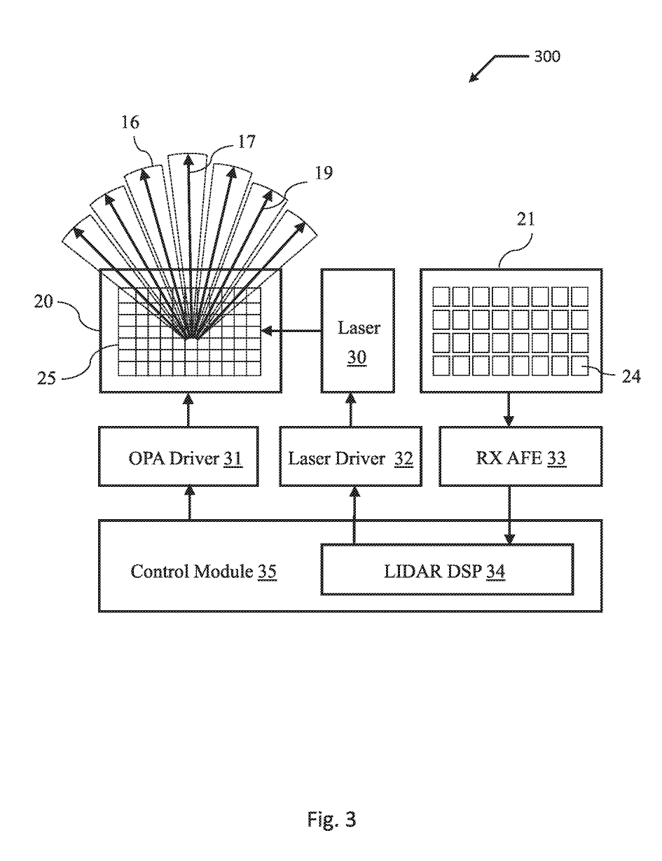

FIG. 3 is a block system diagram of the wide-angle high resolution solid-state LIDAR system according to an example of the present disclosure. The system 300 includes a control module or circuit 35. Control module 35 may be a processor. As used herein, physical processor or processor refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU). Processors may be interconnected using a variety of techniques, ranging from a point-to-point processor interconnect, to a system area network, such as an Ethernet-based network. In an example, one or more physical processors may be in the system 300. In an example, all of the disclosed methods and procedures described herein can be implemented by the one or more processors.

Within the control module 35 is a LIDAR digital signal processing (DSP) module 34, or a LIDAR signal processor, used to process information received from any reflected optical signals. The LIDAR DSP module 34 can function in a variety of ways depending on the type of ranging method employed. For example, the LIDAR DSP module 34 may be a time of flight (“TOF”) processing module. For example, a TOF processing module calculates the depth for each laser beams at each steering angle based on the received signals from a photodetector array. Alternatively, the LIDAR DSP module 34 may be capable of processing information from frequency modulated continuous waves (FMCW) or amplitude modulated continuous waves (AMCW).

The system 300 includes a transmitter portion and a receiver portion. The transmitter portion includes an OPA circuit, such as a transmitter chip/circuit 20, a laser 30, an OPA driver 31 and a laser driver 32. Transmitter chip 20 includes an optical phased array 25 that produces main lobe 17 and grating lobes 19. These lobes can be steered/adjusted within window 16. The steering angle of the laser beams are set by the optical phase shifters, which are driven by the OPA driver frontend 31. The digital control module 35 controls the OPA driver 31. The laser driver 32 is used to drive the laser 30 and generate a similar or identical optical signal for the laser beams simultaneously. The laser driver 32 may be connected directly to LIDAR DSP module 34. In an alternative example, laser driver 32 may not be connected directly to LIDAR DSP module 34, and may alternatively be connected to control module 35. The transmitter portion of the system 300 may include more or less functionality, modules, or features than provided herein.

The receiver portion includes the receiver chip 21 and the receiver frontend 33. The receiver chip 21 includes an array of optical receivers with photodiodes 24. The array in FIG. 3 includes thirty-two optical receivers with photodiodes 24. In an alternative example, there may be more or less optical receivers with photodiodes 24. For example, in an alternative example the number of optical receivers with photodiodes 24 may match the number of lobes (grating lobes plus main lobes) emitted from the antennas. The reflected optical signals are converted to digital electronic signals in parallel by the receiver chip 21 when the reflected signals from the reflected grating lobes and reflected signals from the reflected main lobes are processed simultaneously. The receiver frontend 33 receives reflected optical signals from the receiver chip 21 to continue the processing of the electronic signals. A point cloud (two-dimensional) can thereby be created based on the depth and angle information. Alternatively, a line-scheme (one-dimensional) can be created based on the depth and angle information as well depending on the application. The receiver front end 33 may be directly connected to LIDAR DSP module 34. In an alternative example, the receiver front end 33 may not be directly connected to LIDAR DSP module 34, but alternatively connected to control module 35. In an example, the components of the transmitter portion and receiver portion of FIG. 3 may be located on the same chip, circuit, device, module, etc. In an alternative example, the components of the transmitter portion and receiver portion may be located on separate chips, circuits, devices, modules, etc. The receiver portion of the system 300 may include more or less functionality, modules, or features than provided herein.

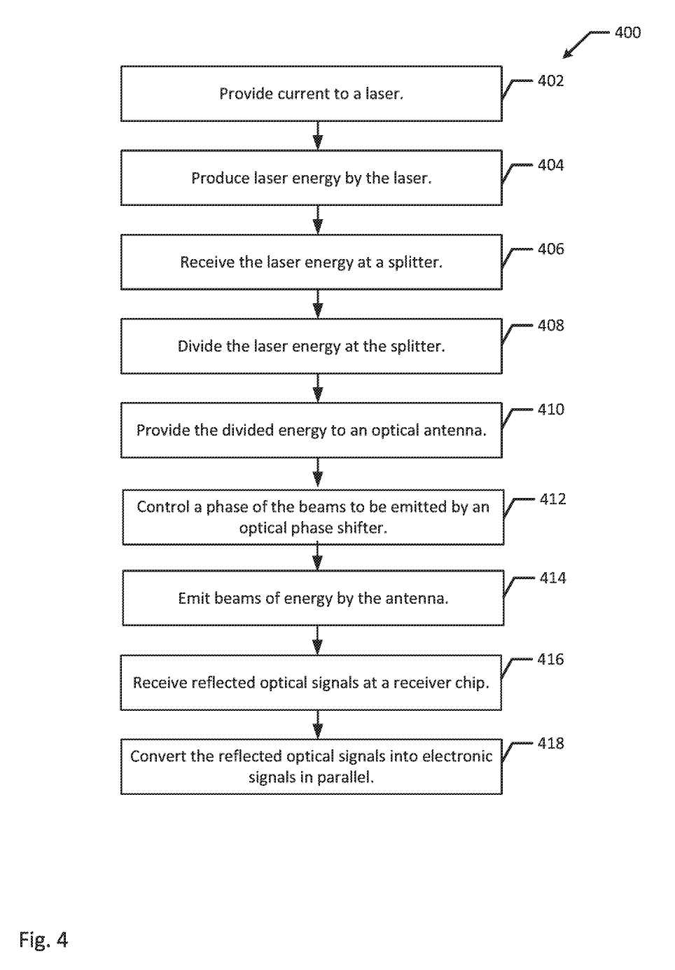

FIG. 4 is a flowchart illustrating an example method 400 for a wide-angle high resolution solid-state LIDAR system. Although the example method 400 is described with reference to the flowchart illustrated in FIG. 4, it will be appreciated that many other methods of performing the acts associated with the method may be used. For example, the order of some of the blocks may be changed, certain blocks may be combined with other blocks, and some of the blocks described are optional.

The method 400 begins by a current being provided to a laser (block 402). For example, in FIG. 3, the LIDAR DSP module 34 and the laser driver 32 provide the laser 30 current to produce a laser beam.

Next, the laser produces laser energy (block 404), the laser energy is received by a splitter (block 406), and the laser energy is divided by the splitter (block 408). For example, laser 30 in FIG. 3 or laser 12 in FIG. 1 produces laser energy, and that energy is provided to splitter 11 from FIG. 1. In an example, the splitter 11 divides the laser energy equally between each optical antenna 14. In an alternative example, the splitter 11 divides the laser energy unequally between the optical antennas 14; further, some optical antennas may not be allotted any laser energy from the splitter 11.

Next, the divided laser energy is provided to an optical antenna (block 410). For example, the energy split at splitter 11 is provided to each optical antenna 14. In an alternative example, the energy split at splitter 11 is provided to only some of the optical antennas 14. For example, an optical antenna 14 may be broken, damaged, or not desired to emit a beam.

Next, the phase of the beams to be emitted by the antennas is controlled by an optical phase shifter (block 412). For example, in order to direct the beams in a particular direction, phase shifters 13 may change or modify the phase of beams to be emitted from optical antennas 14. Each antenna 14 may connected to an optical phase shifter 13. This phase shifter 13 may be used for controlling the phase of the beams before or while the beams are being emitted from the antennas 14. Changing the phase of the emitted pulses or waves allows for the control of the beam's direction. In an alternate example, each antenna 14 may not be connected to an optical phase shifter 13.

Next, laser beams are emitted from the antennas (block 414). For example, main lobe 17 and grating lobes 19 are formed through the constructive interference of the pulses or waves produced from the various antennas 14. These main lobes 17 and grating lobes 19 are transmitted towards a desired target object, and once they hit the target object, some of the wave bounces off the object and are reflected back to the system.

Next, reflected optical signals are received at the receiver chip (block 416). For example, the reflections of grating lobes 19 and main lobes 17 are received at receiver chip 21 by optical receivers 24. In an example, all reflected optical signals are received at the receiver chip. In an alternative example, not all reflected signals are received at the receiver chip as some signals may be deflected, blocked, etc. Further, although a number grating lobes may be produced, not all grating lobes may be used depending on the target being imaged. A small target may require fewer grating lobes being used than all grating lobes produced. Alternatively, a closer or farther target may also require fewer/greater grating lobes. There are a number of reasons why less than all grating lobes would be used or processed by the receiver chip. A chip as used herein refers to a circuit such as, for example, an electronic circuit, an integrated circuit, a microchip, a semiconductor fabricated device, etc.

Last, the received reflected optical signals are converted into electronic signals in parallel (block 418). For example, the received optical signals are converted into electrical signals by the plurality of optical receivers 24 and/or the receiver chip 21. The receiver front end circuit 33 then amplifies the converted electronic signals. Following the receiver front end 33, an Analog to Digital Converter may be used to convert analog electronic signals into digital electronic signal, and a DSP/microprocessors may used to process the digital signals. These electrical signals may be used to create 3D, 2D, or 1D graphical images, or these data points may be stored in a memory or storage device for later use. For example, a 1D line scheme or a point cloud may be created. A memory device refers to a volatile or non-volatile memory device, such as RAM, ROM, EEPROM, or any other device capable of storing data.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A LIDAR transmitting apparatus, comprising:
a control circuit;
a LIDAR signal processor located within the control circuit; and
a transmitter comprising:
an optical phased array circuit,
an optical phased array driver, wherein the optical phased array driver is in communication with the control circuit and controls the optical phased array circuit,
a laser, and
a laser driver, wherein the laser driver is in communication with the LIDAR signal processor and drives the laser.

2. The LIDAR transmitting apparatus of claim 1, further comprising:
the optical phased array circuit is a transmitter circuit.

3. The LIDAR transmitting apparatus of claim 2, further comprising:
the laser is a laser diode located on the transmitter circuit.

4. The LIDAR transmitting apparatus of claim 2, further comprising:
the transmitter circuit includes an optical phased array.

5. The LIDAR transmitting apparatus of claim 4, further comprising:
the optical phased array includes a plurality of optical antennas, including a first optical antenna and a second optical antenna;
a plurality of optical phase shifters, including a first optical phase shifter and a second optical phase shifter, wherein the first optical phase shifter is connected to the first optical antenna, and the second optical phase shifter is connected to the second optical antenna; and
a splitter, wherein the splitter divides optical power from the laser among the plurality of optical antennas.

6. The LIDAR transmitting apparatus of claim 5, wherein the plurality of optical antennas are spaced with a uniform pitch between them.

7. The LIDAR transmitting apparatus of claim 5, wherein the plurality of optical antennas produces a main lobe and at least one grating lobe.

8. The LIDAR transmitting apparatus of claim 7, wherein the at least one grating lobe may be a number of grating lobes between 1 and 6.

9. The LIDAR transmitting apparatus of claim 7, wherein a total number of lobes produced by the plurality of optical antennas is seven, wherein the total number of lobes is the main lobe plus the at least one grating lobe.

10. A LIDAR processing apparatus, comprising:
a control circuit;
a LIDAR signal processor located within the control circuit; and
a receiver comprising:
a photoreceiver, and
a receiver front end circuit, wherein the receiver front end circuit is in communication with the LIDAR signal processor and is coupled to the photoreceiver.

11. The LIDAR processing apparatus of claim 10, further comprising:
the photoreceiver having an optical receiver with a photodiode.

12. The LIDAR processing apparatus of claim 11, wherein a quantity of optical receivers with photodiodes in the photoreceiver corresponds to a total number of lobes, wherein the total number of lobes equals a main lobe in addition to at least one grating lobe produced by a plurality of optical antennas.

13. The LIDAR processing apparatus of claim 10, further comprising:
the photoreceiver having at least one of a plurality of pixels, a plurality of photodetectors, and a plurality of integrated photonic circuits.

14. A method, comprising:
providing, by a laser driver, a current to a laser;
producing, by the laser, laser energy;
receiving, at a splitter, the laser energy;
dividing, by the splitter, the laser energy producing a divided laser energy,
providing, to an optical antenna, the divided laser energy, wherein the optical antenna is connected to an optical phase shifter,
controlling, by the optical phase shifter, a phase of beams to be emitted from the optical antenna;
emitting, by the optical antenna, beams that include a first lobe and a second lobe;
receiving, at a photoreceiver having an optical receiver, reflected optical signals, wherein the reflected optical signals are reflections of the first lobe and the second lobe producing a reflected first optical signal and a reflected second optical signal; and
converting the reflected first optical signal and the reflected second optical signal into electronic signals in parallel.

15. The method of claim 14, further comprising:
operating, by an optical phase driver, the optical phase shifter.

16. The method of claim 14, wherein the optical antenna includes is a plurality of optical antennas, including a first optical antenna and a second optical antenna, the first optical antenna producing a first beam and the second optical antenna producing a second beam.

17. The method of claim 16, further comprising:
generating, by the laser driver, an identical optical signal for the first beam and the second beam.

18. The method of claim 16, further comprising:
tuning a phase difference between the first optical antenna and the second optical antenna.

19. The method of claim 13, further comprising:
generating, from the electronic signals, at least one of a point cloud and a 1D line scheme.

20. The method of claim 14, wherein the first lobe is a main lobe and the second lobe is at least one grating lobe.
